(19) United States
(12) Patent Application Publication
(10) Pub. No.: US 2026/0021520 A1
(43) Pub. Date: Jan. 22, 2026

(54) METHOD FOR BIOMASS PROCESSING TO ENABLE ANOXIC BIOLOGICAL CARBON SEQUESTRATION

(71) Applicants: David Taylor Jackson, Oakland, CA (US); Robert Alden Morris, Oakland, CA (US); Andrew Jordan Felker, Livermore, CA (US); Christian Bach, Southwick, MA (US)

(72) Inventors: David Taylor Jackson, Oakland, CA (US); Robert Alden Morris, Oakland, CA (US); Andrew Jordan Felker, Livermore, CA (US); Christian Bach, Southwick, MA (US)

(21) Appl. No.: 19/271,331

(22) Filed: Jul. 16, 2025

Related U.S. Application Data
(60) Provisional application No. 63/672,006, filed on Jul. 16, 2024.

(51) Int. Cl. B09B 3/35; B09B 3/32; B09B 3/40; B09B 101/70

(52) U.S. Cl. CPC B09B 3/35; B09B 3/32; B09B 3/40; B09B 2101/70

(57) ABSTRACT

A method for anoxic biological carbon sequestration and the resulting product for sequestering carbon is disclosed. The method includes removing moisture content from the biomass to below 37-percent through a carbon-zero drying process, then rendering the dried biomass in a grinding process to particulate that is no greater than 20 mm in any direction, and finally a densification process that forcibly extrudes the dried biomass particulate through an opening at a pressure in excess of 500 psi and with an achieved surface heating beyond 50′C. to enable self-cohesion of the resulting product so that it stays intact as it sinks down through the water column to the anoxic basin.

### CROSS REFERENCE TO RELATED APPLICATION

This application claims the benefit of priority of U.S. provisional application No. 63/672,006, filed Jul. 16, 2024, the contents of which are herein incorporated by reference.

### BACKGROUND OF THE SUBJECT DISCLOSURE

The subject disclosure relates to carbon sequestration and, more particularly, to a method for anoxic biological carbon sequestration, colloquially known as ‘Anoxic Biological Carbon Sequestration’ (hereinafter the “ABC'S Technique”), involving carbon dioxide removal (CDR). This method is described in detail in our U.S. application Ser. No. 18/559,867, which is incorporated in its entirety by reference herein.

The ABC'S Technique works by transporting excess biomatter (which otherwise would decompose back into carbon dioxide) into an anoxic basin. Anoxic basins are submerged, cup-like geological formations, where an absence of water circulation to the larger ocean leads microbes to consume all the oxygen in the basin. In other words, the anoxic basin holds anoxic water that is depleted of dissolved oxygen.

The complete absence of oxygen forms a zone that's hostile to all eukaryotic life—nothing with a mouth (any animals), nothing with roots (any plants), and no fungi and can live in this environment. The lack of oxygen inhibits the metabolic process that would allow the decomposition of lignin, cellulose, and hemicellulose—the key molecules for a plant structure which are largely composed of carbon by mass. Anoxic basins offer the perfect means to sequester vast amounts of carbon dioxide (CO2) by storing excess ubiquitous terrestrial biomass (for instance, corn stalks, sugar cane bagasse, or softwood) that would otherwise decompose back into CO2.

Sinking bulk excess biomass is surprisingly difficult. Excess biomass tends to have low bulk density and a high amount of positive buoyancy. ‘Bulk excess biomass’ refers to unprocessed or loose material (“bulk”), that is not used or desired for other roles (“excess”), in other words, unprocessed available plant matter.

Bulk density is a measure of how much mass can fit into a given volume, including the spaces between particles (interparticle voids) and any pores within the particles themselves. For example, dry sugar cane bagasse has a bulk density of (80-120 kg/m3 or 0.08 to 0.12 g/cm3). Other biomass sources, such as wheat straw or corn stover have similar dry densities. The low bulk density is a result of the sugar cane's internal structure—which has numerous capillaries and air pockets. This is in striking contrast to the density of the sugar cane's underlying molecules, such as cellulose, which has a molecule density of 1.5g/cm3.

The density of water varies by type. The density of freshwater is 1 g/cm3, the density of ocean water is around 1.03 g/cm3, and the density of hypersaline water in some anoxic basins can exceed 1.3 g/cm3. Note, because hypersaline water will infiltrate and displace regular sea water, one only needs to densify material to beyond 1.03 g/cm3, so the biomass sinks from the ocean surface to the hypersaline interface, for this process to work.

Because of the natural buoyancy of the biomass material, high levels of force are required to sink unprocessed material. For the material to be permanently stable in an anoxic basin, the material must be negatively buoyant. Although water pressure will eventually compress the structure of the material, leading to a change from positive to negative buoyancy at around 100-150 m of water depth, lowering highly buoyant material to that depth requires a massive amount of energy and is a complex undertaking at scale.

If the bulk material has a density of 0.1 g/cm3 then one cubic meter of material will produce over 900 kg of buoyancy but can only sequester 100 kg of material. Then for each metric ton (1,000 kg) of material one seeks to sequester, requires applying 9,000 kg of force over 100 m-150 m. Furthermore, if one had 100 kg of biomass that has a positive buoyance of 1,000 kg (or one metric ton of positive buoyancy), assuming the biomass sequesters 100 kg of CO2-e, one will need to apply 900 k of negative buoyancy to just sink 100 kg of CO2-e. This implies a large amount of ‘work’ (force x distance) to sequester a small amount of carbon. As soon as one begins to contemplate sequestering large amounts of CO2-e (say 100,000 tons) it becomes obviously that it will be hugely impractical to ‘weigh-down’ the material with anchors or other sources of negative buoyance (e.g. “ballasts”). To see the extent of the problem, image the material has an unprocessed density of around 0.1 g/cm3 (which is about density of most plant matters). Then, to sink 100,000 tons of biomass would require 900,000 tons of anchoring material-which is totally impractical. However, improving the biomass density such that the material will sink, one needs zero tons of anchoring weights to sink the same 100,000 tons of biomass-a massive improvement. Expanding this much force per ton is infeasible for climatically relevant CDR. Doing so in the open ocean, above an anoxic basin, only increases the difficulty.

As can be seen, there is a need for a method for anoxic biological carbon sequestration embodying negating the buoyancy of biomass, whereby changing the bulk density of the biomass facilitates sequestration by making the biomass naturally sink.

### SUMMARY OF THE SUBJECT DISCLOSURE

The disclosure of the subject disclosure provides improvements to the Anoxic Biological Carbon Sequestration (ABC'S) Technique. More specifically, the subject disclosure describes steps for the densification of bulk excess biomass that will compress the biomass to densities greater than 1.03 g/cm3. This allows the biomass to naturally sink both in fresh water, ocean water, and hypersaline water.

In one aspect of the subject disclosure, a method for achieving biomass negative buoyancy without adding any ballast includes drying biomass to below 37% moisture content; shredding biomass so that rendered pieces are less than 20 mm in length in any direction; and compressing biomass using a mechanical or hydraulic method to above 500 psi, wherein the resulting form factor is a pellet form factor, wherein the resulting form factor is a briquette form factor, wherein the resulting form factor is a brick or cube form factor, wherein the form factor is another extrusion form factor, wherein the output is less than 37% moisture content, wherein a sterilization technique is applied to the biomass either before or after densification, wherein the sterilization technique is radiation or heat, wherein decomposition (both for final storage and transport) is inhibited by the process, wherein decomposition (both for final storage and transport) is inhibited, or wherein the material is kept in solid form and does not shed material without requiring encasement or other forms of wrapping.

In another aspect of the subject disclosure, a carbon-bearing object having a specific gravity, relative to water, of greater than 1.3 composed only of biomass with only the addition of heat and pressure to dried biomass is provided for densifying biomass to achieve negative buoyancy, the method further including the following: heating water to between 50-85 degrees Celsius using one or more air-source heat pumps; supplying said water to a biomass drier; using field drying to achieve the correct water content of <37%; using an efficient gas fired drier to achieve water content of <37%; using a solar thermal system to heat a drier to achieve water content of <37%; heating said biomass to at least 120 degrees Celsius using said biomass drier; and performing a densification technique to densify said biomass, wherein said biomass drier is a high-flow low-temperature drier, wherein said densification technique is a pelletization, briquetting, or cubing process, wherein the output or resulting product is a continuous extrusion whether the extrusion is injected directly to a hypersaline basin, or the extrusion is broken or formed into pieces for transport, or wherein an additional pump is located between said two or more air-source heat pumps and said biomass drier.

In yet another aspect of the subject disclosure a method for densifying biomass to achieve negative buoyancy includes the following: heating water to between 50-85 degrees Celsius using two or more air-source heat pumps, wherein said water from each of said two or more air-source heat pumps is combined in a valve; supplying said water to a biomass drier; heating said biomass to at least 120 degrees Celsius using said biomass drier; and performing a densification technique to densify said biomass, wherein an additional pump is located between said two or more air-source heat pumps and said biomass drier, wherein said biomass drier is a high-flow low-temperature drier, or wherein said densification technique is a pelletization, briquetting, or cubing process.

In still yet another aspect of the subject disclosure a method for densifying biomass to achieve negative buoyancy includes the following: heating water to between 50-85 degrees Celsius using two or more air-source heat pumps, wherein said water from each of said two or more air-source heat pumps is combined in a valve; supplying said water to a biomass drier; heating said biomass to at least 120 degrees Celsius using said biomass drier; and performing a densification technique to densify said biomass.

### BRIEF DESCRIPTION OF THE DRAWINGS

FIG. 1 is a flow chart of an exemplary embodiment of the subject disclosure, illustrating biomass processing for sinking in an anoxic basin.

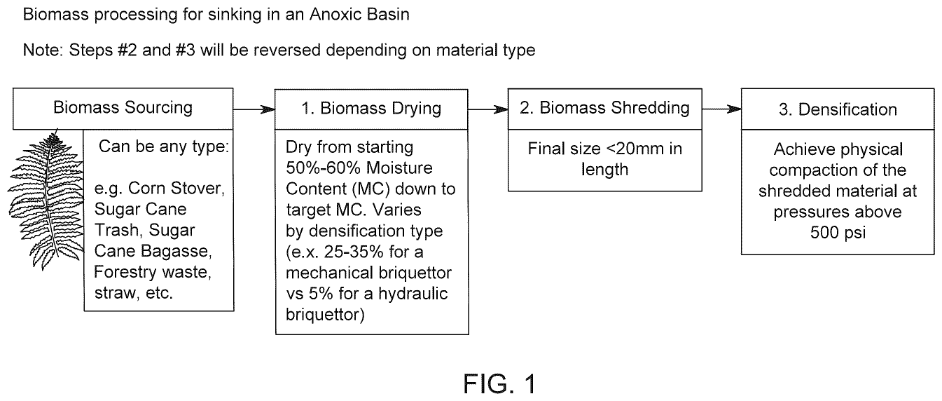

FIGS. 2A, 2B, and 3 are perspective views of an exemplary embodiment of the subject disclosure, illustrating differently prepared densified biomasses that sink after briquetting.

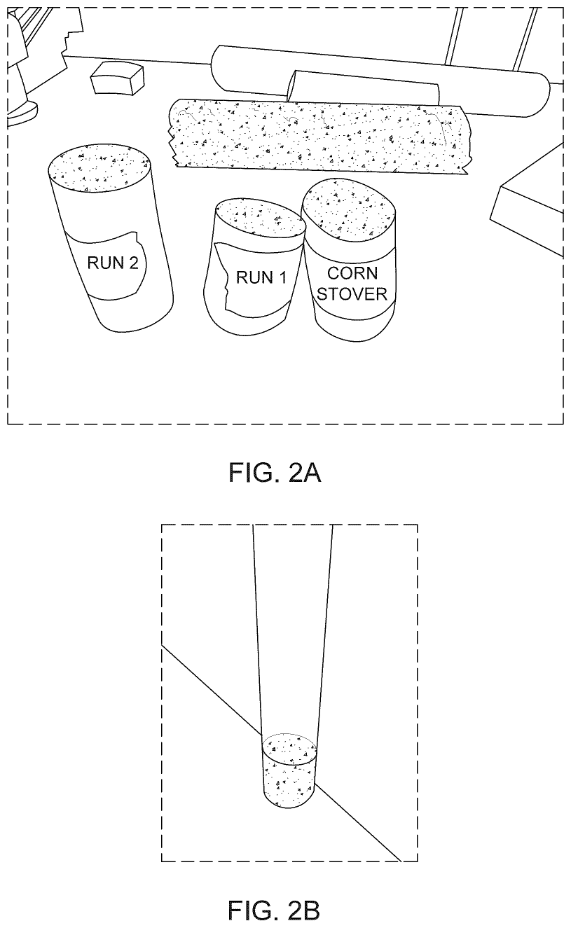

FIG. 4 is a perspective view of an exemplary embodiment of the subject disclosure, illustrating a recovered deep-sea lander (capable of spending approximately 200 days on the bottom of an anoxic basin at approximately 7,000 ft of water depth) thereby enabling testing how the material behaves (both mass loss and decomposition) in an anoxic water basin.

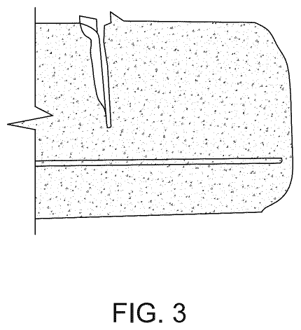

FIG. 5 is a perspective view of an exemplary embodiment of the subject disclosure, illustrating a “sinking test” of a collection of biomasses held in a manilla rope net and lowered in a water column; via a set of pressure loggers one can observe the sinking rate in comparison to the rate the winch can unspool at, enabling defining a minimum bound on the sinking rate through the water column.

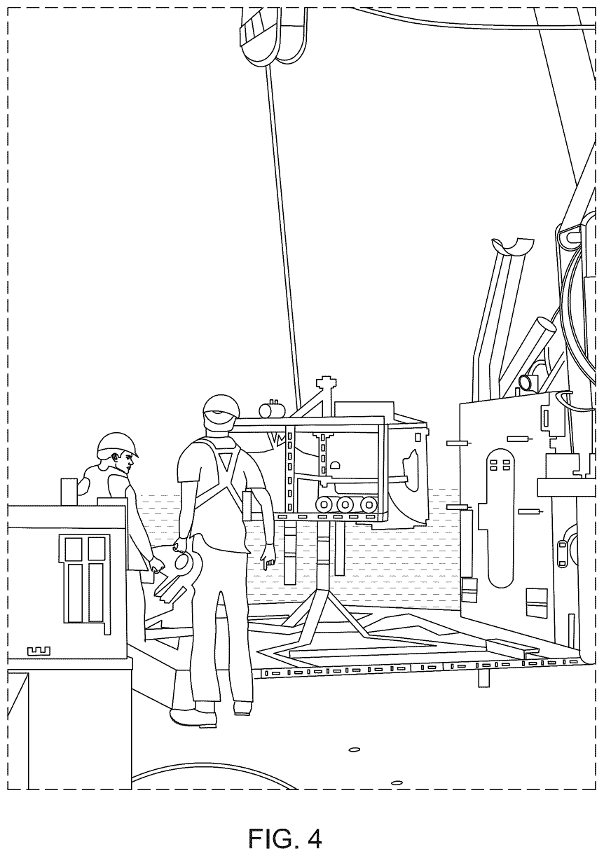

FIG. 6 is a perspective view of an exemplary embodiment of the subject disclosure, illustrating output of biomass densified via a hydraulic briquettor, wherein the biomass has been compressed to high pressure forming a ‘densified brick’ that can be sunk in ocean water.

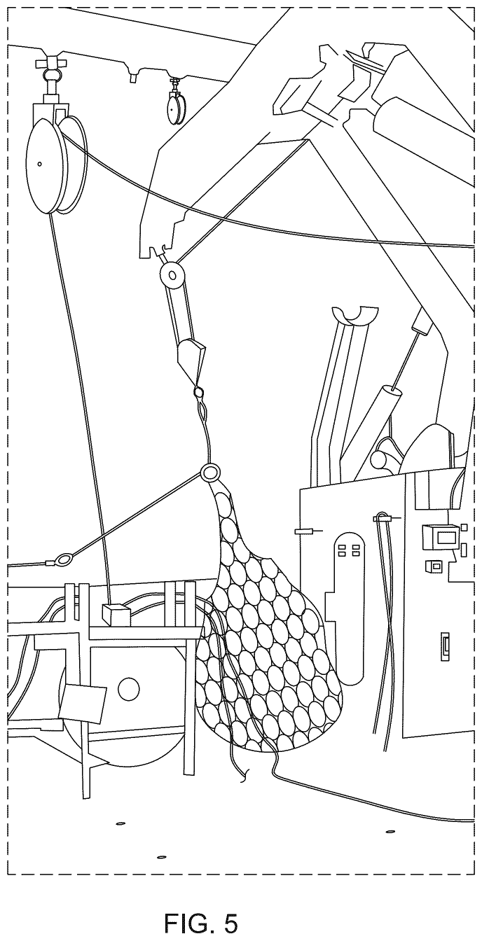

FIG. 7 is a perspective view of an exemplary embodiment of the subject disclosure, illustrating examples of biomass, densified by use of a hydraulic briquettor, that sunk in fresh water. The bricks are wrapped in burlap in case of any material degradation (none was observed). These experiments prove multiple different densification technologies for methods embodied in the subject disclosure.

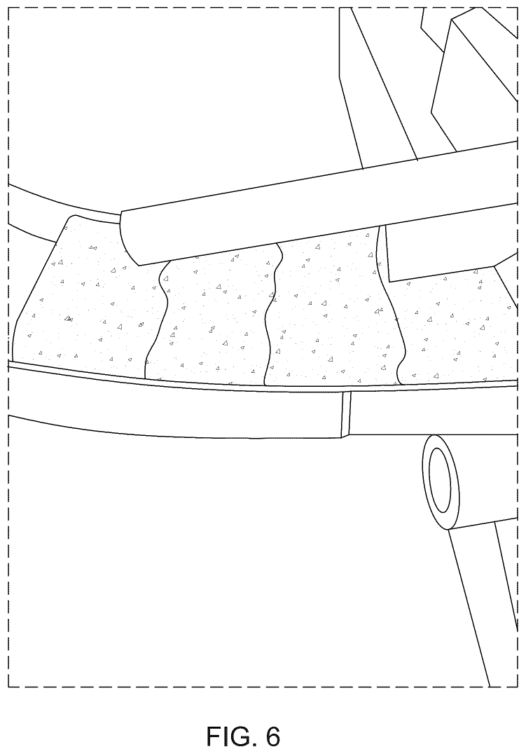

FIG. 8 is a perspective view of an exemplary embodiment of the subject disclosure showing a mechanical piston-driven briquettor.

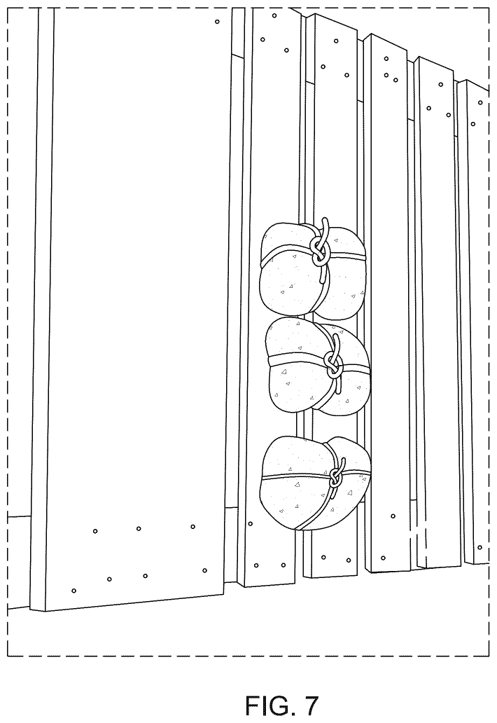

FIG. 9 is a perspective view of an exemplary embodiment of the subject disclosure illustrating pellets of biomass.

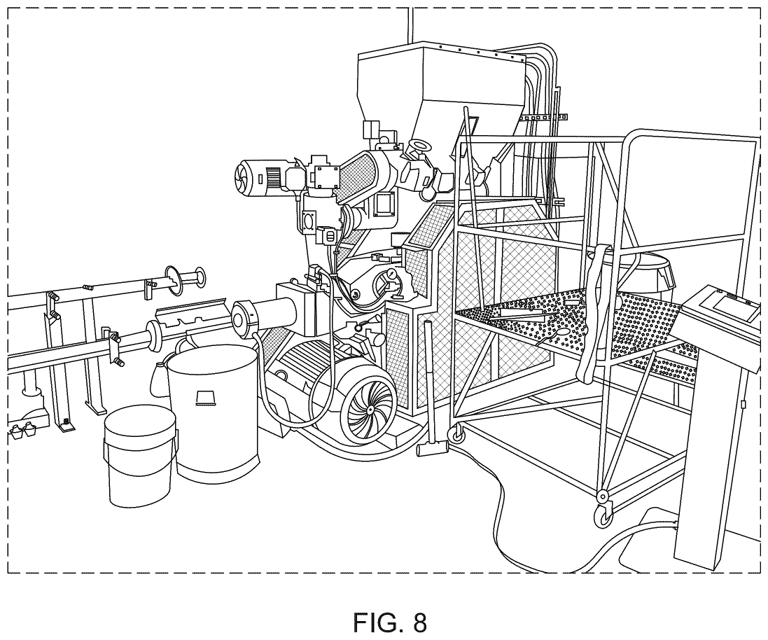

FIG. 10 is a perspective view of an exemplary embodiment of the subject disclosure showing a hydraulic briquettor.

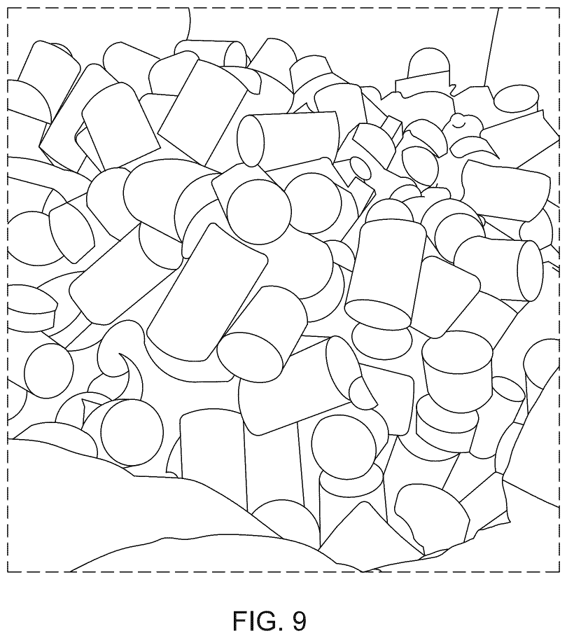

FIG. 11 is a schematic view of a heating system for heating water using two or more air-source heat pumps 10 wherein the water from each of said two or more air-source heat pumps is operatively associated via a valve 20.

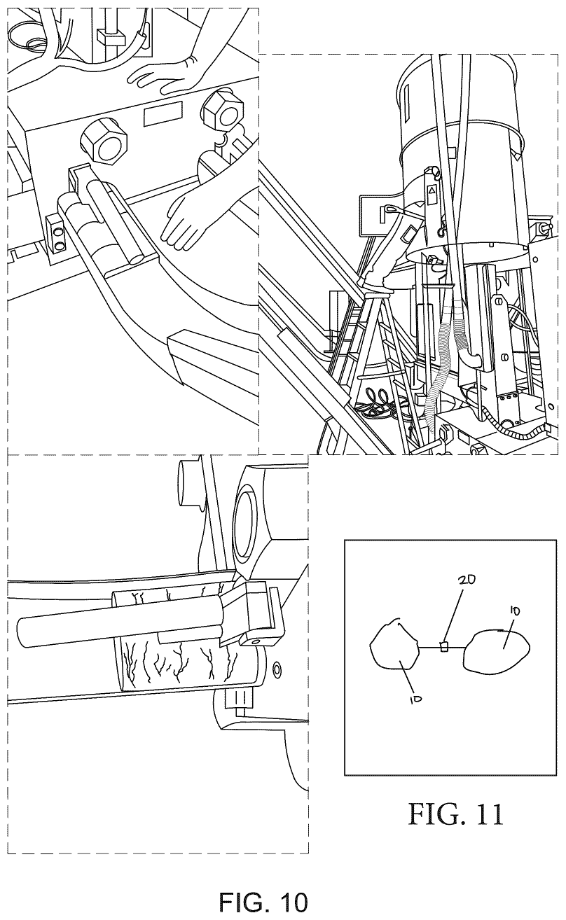

### DETAILED DESCRIPTION OF THE SUBJECT DISCLOSURE

The following detailed description is of the best currently contemplated modes of carrying out exemplary embodiments of the subject disclosure. The description is not to be taken in a limiting sense but is made merely for the purpose of illustrating the general principles of the subject disclosure, since the scope of the subject disclosure is best defined by the appended claims.

Broadly, the subject disclosure embodies a method and system optimized for application to Carbon Dioxide Removal (CDR) to minimize both the energy expended and the carbon dioxide emitted by the process—i.e., to maximize the carbon efficiency for a carbon sequestration procedure.

Processing material takes three major steps: (1) drying biomass, (2) grinding biomass, and (3) densifying biomass. The subject disclosure provides unique improvements to the drying and densification steps.

The chain of requirements for the ABC'S Technique requires multiple steps to work together. Without drying or grinding, densification would not be possible. Densification radically simplifies the CDR process because it allows natural sinking to transport the material through the water column into the anoxic basin. Once biomass is densified to a negative buoyancy (specific gravity greater than 1.03 g/cm3) the resulting biomass may be simply dropped into the ocean above the anoxic basin. It will naturally sink.

The densification process requires specific temperature and pressure conditions to succeed as well as grinding to reduce its size. Without grinding the densification machines cannot run efficiently. The grinding step requires minimizing material below a set moisture content—i.e. dry material. And the drying step requires minimizing CO2 emissions. Without these chained requirements Anoxic Biological Carbon Sequestration (ABC'S) would not be economic, physically feasible, or carbon efficient. Only when these steps are combined do they allow carbon efficient processing at land to enable rapid and safe activity at sea.

Examining each requirement as a separate bullet point shows how they are combined to enable ABC'S embodied in the subject disclosure.

The requirement of easily sinking biomass in the ocean (as an alternative to “pulling it” below 100-150+ meters of depth) requires biomass to be densified beyond 1.03 g/cm3.

The requirement of densifying biomass beyond 1.03 g/cm3 requires both grinding it to reduce its size (below 20 mm—screen size), applying high pressure >500 psi, and heating its surface beyond 50-degrees C.

The requirement of grinding the biomass to “below 20 mm−” requires the drying of the biomass material to lower its moisture content to below 37%. Biomass on the field can often be at 50% moisture contents.

The requirement for drying is accomplished with minimal (and preferably zero) carbon dioxide emissions. This requirement is in strong contrast with the overwhelming use of natural gas driers which are inherently combustion based.

Finally, CO2-free drying must be able to succeed at a low cost and in a high humidity environment. As otherwise both the carbon efficiency and economic efficiency of the ABC'S process would be severely compromised.

By working backwards from the desired end state (efficient sinking of excess terrestrial biomass in an anoxic basin) a combined set of sequential processes were developed enable ABC'S.

The individual steps are described below in the ‘flow-forward’ direction. The ‘flow-forward’ direction means the process steps are described in the order in which the biomass is processed.

The process begins with bulk excess, terrestrial, biomass, such as sugarcane bagasse. Please note, any biomass source can be a useful input to this process. For example, excess corn stalks (corn stover), forestry trimmings or waste, or any agricultural waste or stalks offer a useful form of solid carbon that can be processed for sequestration with the following steps.

Bagasse is a waste product from sugar mills that commonly has a moisture content of over 50%. In open air piles, bagasse moisture content (MC) can exceed 60% or 70%. Likewise, most forms of biomass (such as corn stalks or other waste plant stalks) are available at approximately 50% MC. Drying the material is critical for the densification process. Otherwise, the high moisture content will prohibit both the grinding and compression of the material. Traditionally, biomass drying is done with a rotary drier powered by natural gas or excess biomass. Alternatively, a high-airflow low-temperature drier may be used in areas with waste process heat. However, all these approaches assume combustion; either by burning natural gas, burning excess biomass, or combustion providing the alternate source of waste heat. This combustion is problematic for our CDR process as its CO2 emissions reduce the total carbon efficiency of our process—either by directly releasing CO2 from fossil fuels (in the case of natural gas) or reducing the amount of biomass we can sequester (in the case of burning excess biomass).

The subject disclosure embodies a high-efficiency heat pump electric drier-which allows low cost drying powered, ideally with electricity from renewable sources.

An electric heat pump for hot water is used to power a high-flow airflow low-temperature drier. High-flow airflow, low temperature driers are known, but they previously have only been powered by either natural gas burning or waste heat sources such as co-generation. A feature of the subject disclosure is that the biomass drier is directly powered by an electric heat pump. The heat pump supplies hot water between 50-85 degrees Celsius to the biomass dryer.

No existing driers are configured to be powered by electricity in this manner. There are major advantages to such a process:
1. Emissions. Compared to traditional biomass driers that are powered via biomass burning, natural gas, or using industrial waste heat, air-source heat pumps can work with no additional emissions. This is a massive improvement in current practice that saves multiple megawatts of burning material per ton dried of biomass. Being emission free also allows a manufacturing facility to forgo highly expensive emissions control systems (e.g., a WECS system). This produces dramatic monetary savings per ton of dried material.
2. Regulatory burden. Because the heat pump biomass drier does not require combustion, it does not require expensive regulatory compliance steps to ensure that its emissions follow air quality standards. This removes expensive permitting and regulatory compliance actions.
3. Cost effectiveness. Electric air-to-water heat pumps are efficient and low maintenance. Electric resistance heating (without using a heat pump) would require 3-4 times more total energy, making electric resistance heating prohibitively expensive. Using a heat pump for biomass drying allows emissions free approaches to be cost competitive with prior combustion driers. Additionally, heat pumps can operate for decades or more with little maintenance. This is in striking contrast to machines like combustion rotary driers (used for most bagasse drying) that require extensive cleaning and maintenance in response to the soot generated by the combustion process.

Using a heat pump introduces additional opportunities for process optimization. In a heat pump drier, the heat pump transports heat from a general medium (e.g. air source, ground source, or water source) into a resultant steam of heat (e.g. hot water or hot air). This allows the material to proceed to the next step-grinding, which achieves size reduction. For the densification step to enable sinking to anoxic water depth, the inventors have discovered preferable size reduction to a specification of “below 20 mm−”. Specifically, “20 mm−” (pronounced 20 mm minus) means that no resulting fiber is longer than 20 mm in any direction. This grinding step is critical for the following densification step.

Densification technology leverages established methods (pelletization, briquetting, or cubing) and then modifies the operating parameters of the specific machine to meet the needs of the ABC'S process—which often leads to a set of operating parameters not in established use with this equipment. Pelletization forces material out from the center of an internal cassette with small (˜2-5 mm) extrusions holes. Pelletization works by having screw rollers, inside the cassette, generate large external forces. The cassette is a cylinder with many extrusion openings facing the outside. The cassette is typically two to three feet in diameter (i.e. approximately 60 cm-90 cm in diameter).

Briquetting may use either a screw compressor or an impact ram to force material out of a single extrusion mandrel. Briquettes typically output material at 5 cm-12 cm in diameter. There are two major types of briquetting technology: mechanical and hydraulic briquettors—through experimentation, the inventors have demonstrated that either approach can be successful. A mechanical briquettor has a flywheel that drives a linear piston in and out of a chamber. When the piston drives forward into the chamber the resulting high pressure extrudes the material out through a mandrel. Pressures in the mandrel can meet or exceed 4,000 psi but a minimum of 500 psi is necessary. A hydraulic briquettor may include a hydraulic press that “pushes down” on the biomass at high pressure, achieving high densities. While hydraulic briquettors require dryer material than mechanical briquittors (e.g. ˜5% MC for hydraulic briquettors vs. 50%+ for mechanical briquettors) both approaches have been demonstrated to successfully enable sinking of densified biomass for this application of carbon sequestration.

Cubing is a vastly scaled up version of pelletization utilizing a “cuber”. The cuber uses a cassette that can be arbitrarily large, but the cassette can exceed 2 m in diameter. Likewise, the output ‘cubes’ of material from the cuber are significantly larger than the outputs of a pelletizer. All three of these machines increase the density of material.

Densification technology (e.g. pelletization, briquetting, or cubing processes) is used to densify the material to a specific density greater than 1.03 g/cm3. These processes work by forcibly extruding biomass through an opening or a mandrel at an extremely high pressure. For the subject disclosure to work correctly, the extrusion pressure must exceed 500 psi and achieve surface heating beyond 50′C. These requirements are necessary to get the biomass to ‘self-cohere’ such that the densified material stays intact as it sinks down through the water column to the anoxic basin.

If the internal structure of the extruded biomass material does not change during the densification step, then after the material is released from the densification machine and placed in water, the material will not sink.

For carbon sequestration briquets the disclosure provides a novel method of making sequestration briquets that require minimal preprocessing and go outside the bounds of fuel pellet processing on many key parameters. Critically, the subject disclosure uses pressures of at least 500 psi and exit temperature of material above 50′C and input particles of less than 20 mm-size, for any biomass, that allows for large, high density briquets suitable for ABC'S.

We have observed that different microbial communities can influence the decomposition rates of the biomass either during transport or on the basin. The sterilization process for the biomass may be used either before densification or after densification. Examples of sterilization, that do not use additives to the biomass, include a) using gamma radiation for sterilization (like in food processing) or b) using heat in sterilization. Either approach can kill off microbial communities to further impede decomposition if this is deemed necessary.

A key requirement of our process is minimization of total CO2 emissions when enabling ABC'S Carbon Sequestration approach. In general, if 1-metric-dry-ton of biomass embodies approximately 1.42 metric tons of CO2 (specific embodied CO2 will vary by biomass type and competition) we need to emit less than 10% of that carbon in processing, and we like to target <2% of embodied carbon emissions in our processing steps. Detailed Life Cycle Analysis (LCA) models of our process show that only by utilizing CO2 emissions free drying (as opposed to gasification or natural gas drying) can we meet our stringent CO2 emissions goals.

As used in this application, the term “about” or “approximately” refers to a range of values within plus or minus 10% of the specified number. And the term “substantially” refers to up to 80% or more of an entirety. Recitation of ranges of values herein is not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the subject disclosure and that modifications may be made without departing from the spirit and scope of the subject disclosure as set forth in the following claims.

What is claimed is:

1. A method for achieving biomass negative buoyancy without adding any ballast.

2. The method of claim 1, further comprising:
a. drying biomass to below 37% moisture content;
b. shredding biomass where pieces are less than 20 mm in length in any direction; and
c. subjecting the shredded biomass to a compressive force in excess of 500 psi.

3. The method of claim 2, wherein a product resulting from the compressive force is a pellet form factor.

4. The method of claim 2, wherein a product resulting from the compressive force is a briquette form factor.

5. The method of claim 2, wherein a product resulting from the compressive force is a brick or cube form factor.

6. The method of claim 2, wherein a product resulting from the compressive force is an extrusion form factor.

7. The method of claim 2, wherein a product resulting from the compressive force has a less than 37% moisture content.

8. The method of claim 2, wherein a sterilization technique is applied to the biomass either before or after densification, wherein the sterilization technique is radiation or heat.

9. The method of claim 8, wherein decomposition, both for final storage and transport, is inhibited by said sterilization technique.

10. The method of claim 8 wherein decomposition, both for final storage and transport is inhibited.

11. The method of claim 2, wherein the material is kept in solid form and does not shed material without requiring encasement or other forms of wrapping.

12. The method of claim 11, wherein regularly shaped, carbon bearing object having a specific gravity of greater than 1.3 composed only of biomass with only the addition of heat and pressure to dried biomass.

13. A method for densifying biomass to achieve negative buoyancy, said method comprising:
a. heating water to between 50-85 degrees Celsius using one or more air-source heat pumps;
b. supplying said water to a biomass drier;
c. Using field drying to achieve the correct water content of <37%;
d. Using an efficient gas fired drier to achieve water content of <37%;
e. Using a solar thermal system to heat a drier to achieve water content of <37%;
f. heating said biomass to at least 120 degrees Celsius using said biomass drier; and
g. performing a densification technique to densify said biomass.

14. The method of claim 13, wherein said biomass drier is a high-flow low-temperature drier.

15. The method of claim 13, wherein said densification technique is a pelletization, briquetting, or cubing process.

16. The method of claim 13 wherein the output is a continuous extrusion whether the extrusion is injected directly to a hypersaline basin, or the extrusion is broken or formed into pieces for transport.

17. The method of claim 13, wherein an additional pump is located between said two or more air-source heat pumps and said biomass drier.

18. A method for densifying biomass to achieve negative buoyancy, said method comprising:
a. heating water to between 50-85 degrees Celsius using two or more air-source heat pumps, wherein said water from each of said two or more air-source heat pumps are operatively associated via a valve;
b. supplying said water to a biomass drier;
c. heating said biomass to at least 120 degrees Celsius using said biomass drier; and
d. performing a densification technique to densify said biomass.

19. The method of claim 18, wherein an additional pump is located between said two or more air-source heat pumps and said biomass drier.

20. The method of claim 18, wherein said biomass drier is a high-flow low-temperature drier.

21. The method of claim 18, wherein said densification technique is a pelletization, briquetting, or cubing process.

22. A method for densifying biomass to achieve negative buoyancy, said method comprising:
a. heating water to between 50-85 degrees Celsius using two or more air-source heat pumps, wherein said water from each of said two or more air-source heat pumps are operatively associated via a valve;
b. supplying said water to a biomass drier;
c. heating said biomass to at least 120 degrees Celsius using said biomass drier; and
d. performing a densification technique to densify said biomass.
